(19) United States
(12) Patent Application Publication
(10) Pub. No.: US 2022/0396468 A1
(43) Pub. Date: Dec. 15, 2022

(54) VARIABLE FLOW FLUID EXCHANGE MACHINE

(71) Applicant: NORCO INDUSTRIES, INC., Compton, CA (US)

(72) Inventors: Jeff Romero, Compton, CA (US); Dave Werthmann, Compton, CA (US)

(73) Assignee: NORCO INDUSTRIES, INC., Compton, CA (US)

(21) Appl. No.: 17/836,965

(22) Filed: Jun. 9, 2022

Related U.S. Application Data
(60) Provisional application No. 63/209,910, filed on Jun. 11, 2021.

(51) Int. Cl. B67D 7/36; B67D 7/84; B67D 7/02; B67D 7/62; F16H 57/04; F15B 15/18; F15B 13/02; F15B 13/044

(52) U.S. Cl. CPC B67D 7/36; B67D 7/845; B67D 7/02; B67D 7/62; F16H 57/0408; F15B 15/18; F15B 13/027; F15B 13/044; B67D 2210/0001; B67D 2210/00133; B67D 2210/00102

(57) ABSTRACT

A vehicle fluid exchange machine is disclosed that allows the technician to control the flow into the vehicle or stand-alone cooling or hydraulic system either manually or automatically based on a safe working pressure for the vehicle. If the vehicle's cooling system can handle a higher pressure for example, the technician may adjust the machine's flow to a flow rate consistent with the higher pressure rating while monitoring the pressure across the system. The default setting for the air injection process is automatic, but can also be switched to manual by the technician.

### CROSS-REFERENCES TO RELATED APPLICATIONS

This application claims priority to U.S. Provisional Patent Application No. 63/209,910, filed Jun. 11, 2021, the content of which is incorporated by reference herein in its entirety.

### BACKGROUND

The present invention is directed to a fluid exchange machine for servicing vehicles, trucks, and other equipment that can vary the delivery of various automotive service fluids based on the capacity and capability of the component of the vehicle to be serviced.

In fluid exchange machines, it is customary to have one fluid exchange machine for cars and a separate one for trucks. Trucks use a machine that can deliver six to eight gallons per minute, whereas cars have machines that deliver about half that amount. For service stations that handle both types of vehicles, it is expensive and inconvenient to require both types of fluid exchange machines with their inherent parts and maintenance.

The present invention is a variable flow fluid exchange machine that can service both trucks at a higher flow rate and cars at a lower flow rate by adjusting the flow rate using ideally a manual priority flow control valve, or alternately a needle valve, proportional flow control valve, or variable speed pump can be used. Using this technology allows service proprietors to carry a single machine at a reduced cost, and can also vary the flows as needed for the particular application.

### SUMMARY OF THE INVENTION

The heavy duty heated fluid flusher for vehicles that includes a variable high capacity flow capability with preprogrammed flush cycles for use with transmission cooler systems and hydraulic systems. The machine of the present invention flushes and cleans transmission coolers and lines or any hydraulic system of contamination, sludge, varnish deposits, and particles from a failed transmission. It has an adjustable flow rate from preferably between one and eight gallons per minute and is designed for heavy duty transmission cooling systems requiring high flow rates. Using the same hydraulic fluid as the hydraulic system being flushed and cleaned, a user may select from multiple flush cycles ranging from fifteen to one hundred twenty minutes, and verify system cleanliness by checking a reusable sixty micron cleanable filter screen. Using its heating circulation mode, the present invention can heat the recirculating fluid to a preset 140° F. in 45 minutes. Preprogrammed flush cycles inject air into the flow to agitate the system and create a scrubbing action, removing trapped debris and solidified waxy varnish deposits for removal. Controls allow the user to easily switch flow direction without removing service hoses during and between flush cycles using a reverser valve. From the conveniently located control panel, the user can observe system flow, pressure, temperature, total hours run, filter timer, and easily select pump on/off, heater on/off, flush cycles, and manual air purge.

In one preferred embodiment, the present invention utilizes a fixed displacement gear pump to deliver heated transmission fluid or other fluids to a vehicle or stand-alone cooling or hydraulic system. A pump that can be driven by an AC or DC motor is mounted on the fluid exchange carriage. To determine the proper flow, the machine can be equipped with pressure sensors that determine the back pressure building up in the system and adjust the flow rate accordingly based on a software protocol that reduces the opportunity for excess pressure to occur and potentially damage the vehicle component being flushed or the fluid exchange machine. In a preferred embodiment, fluid flows through a pressure compensated, manual priority flow control valve with an internal relief valve. Flow is adjusted manually by observing the flow meter readout.

An air injection point is located just after a flow meter and before a reversing valve as a means to optionally introduce bursts of air into the fluid flow periodically to increase fluid agitation of the internal surfaces to improve cleaning. Pressure sensing is done ahead of or across of the reversing valve. This pressure sensing provides a signal which can be used by the controller to operate the proportional flow control valve and thereby control the fluid flow delivered to the component being flushed. Additionally, the reversing valve can be used to change the direction of the flow after the specified cleaning interval is completed and a visual inspection of the filter screen is performed. If further cleaning is needed, the flow may be manually reversed and a new cleaning cycle is performed. This process is repeated until inspection of the filter screen is determined to be free of contamination. Alternately, an automated reversing valve can be integrated in place of the manual reverser valve to allow the controller to perform a set number of reversing cycles as part of the cleaning regimen.

The unit may be driven by a ¾ horse power motor and use a dedicated 20-amp or two separate 15-amp circuits. A pair of heavy duty ¾∝1 ID service hoses convey the fluid to and from the vehicle from a ten gallon fluid tank, including a level sight glass to gauge fluid level. The adjustable flow rate allows cleaning low to high flow hydraulic systems and sensors shut down the system when the fluid level drops below a critical level. The reverser valve allows easy flow reversal without removing service hoses, and two auto-selected GPM-dependent flush patterns are preprogrammed to specifically control the amount and timing of air being injected into the hydraulic fluid flow and thereby creating an agitating scrubbing action to remove trapped debris and solidified waxy varnish. An air purge feature allows for easy fluid removal from system and service hoses

The present invention allows the user to control the flow of fluid automatically based on a safe working pressure for the component to be flushed. That is, if the component can handle a higher pressure then the flow will be adjusted to a flow rate consistent with a higher rating by monitoring the pressure ahead of or across the component. This helps to minimize the time it takes to perform the service by using higher (albeit safer) flow rates. A pressure transducer in combination with a controller and VFD motor driven pump or proportional flow control valve may be used to automatically adjust the flow rate as well.

### DESCRIPTION OF THE FIGURES

FIG. 1 is an elevated, perspective view of a first preferred embodiment of the invention;

FIG. 2 is an example of an air burst cycle that may be used in conjunction with the fluid exchange machine; and

FIG. 3 is a schematic diagram of a fluid flushing machine of the type embodied by the present invention.

### DETAILED DESCRIPTION OF THE PREFERRED EMBODIMENTS

The present invention is a vehicle fluid exchange machine that allows the technician to control the flow into the vehicle or stand-alone cooling or hydraulic system either manually or automatically based on a safe working pressure for the vehicle. If the vehicle's cooling system can handle 70 psi of pressure for example, the technician may adjust the machine's flow to a flow rate consistent with this rating while monitoring the pressure across the system. The default setting for the air injection process is automatic, but can also be switched to manual by the technician. When in automatic mode, a program is performed by the controller to have the machine conduct the following steps.

The controller monitors four parameters (which can be changed at the technician's discretion by using the user interface at the setup prompt and adjusting the settings) to control:

1. Length of time that the air is introduced to the flow of the working fluid;

2. Length of time that the air is turned off to the flow of working fluid;

3. Number of times that item 1 occurs; and

4. Length of time to wait until item 1-3 is repeated.

The timing and iterations can be explored to determine the best “routine” for cleaning the cooler and program those settings into the machine for future use.

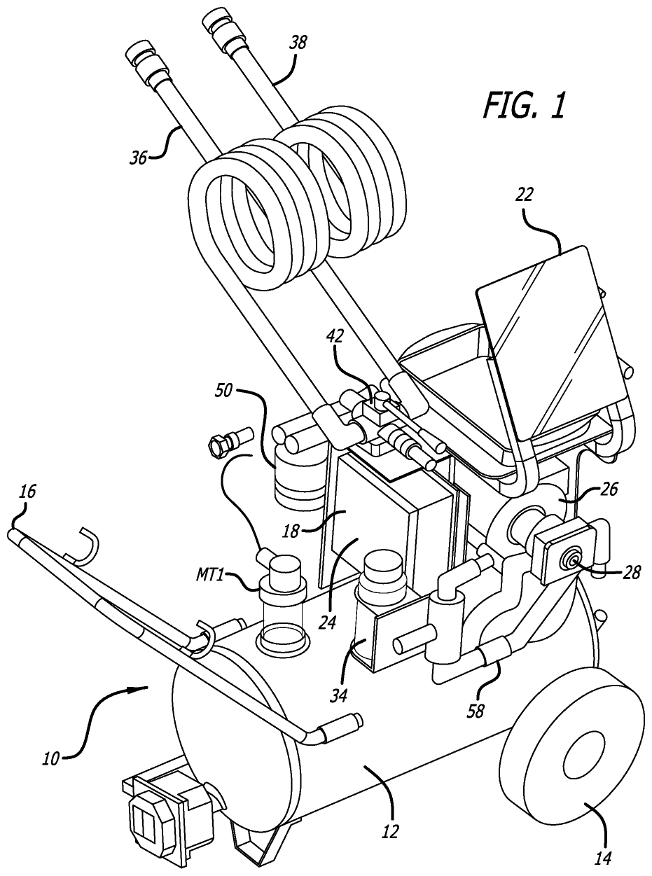

FIG. 1 illustrates a preferred embodiment of the present invention. The fluid exchange machine 10 includes a fresh fluid tank 12 that is mounted on an axle supporting two wheels 14 so that the machine 10 can easily be moved adjacent a vehicle as needed. A convenient handle 16 can also be provided to steer or pull the machine 10 into position. An electrical power module 18 is connected to the support frame and receives electrical power from a standard power outlet via an electrical cable to allow for standard shops to utilize the machine on a fifteen amp breaker typically found in these locations. Two hoses 36, 38 are connected to a manual switching valve 42 that allows the flow to reverse direction when required by the conditions of the vehicle's component. A check valve 58 is located downstream of the pump to ensure that air is directed in the direction of fluid flow when purging fluid from the hoses.

A display panel 22 provides a user with an LED display and incorporates various buttons, knobs, or inputs to activate and operate the machine 10. The controller 40 in the power module 18 is programmed to conduct the various fluid exchange operations utilized by the machine, and the system can be programmed to control the pump automatically using the motor so as to run for a specified period of time selectable by the user which when complete is signaled by the machine by various tones, lights, and screen messages.

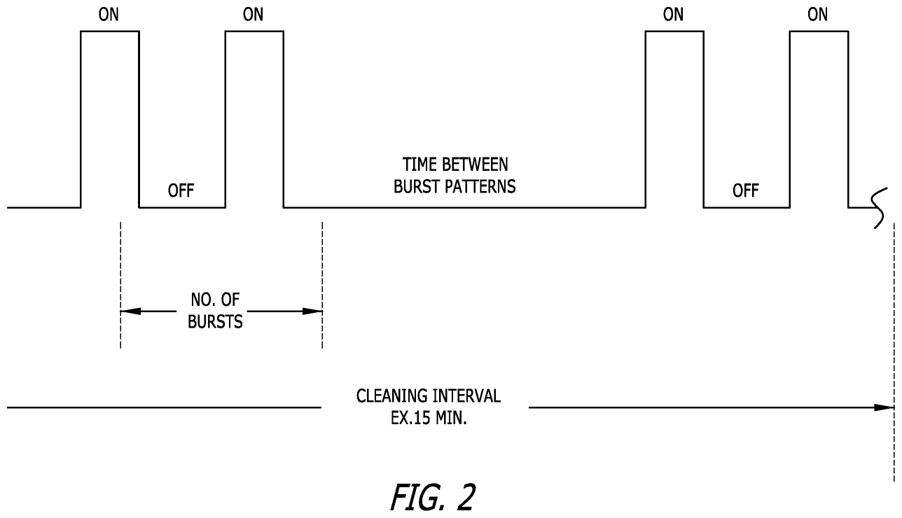

The machine 10 includes a ¾ horsepower electric motor 26 that drives a fluid pump 28. The fluid pump 28 delivers fresh fluid from the tank 12 into the vehicle's cooling/transmission/brake system 30 while flushing the old, leftover fluid through a fine mesh screen 48 and through a ten to twenty micron filtration filter 50. The fluid then returns to the main tank 12 (with optional heating if required) and is recirculated back through the component. Air injection is programmatically controlled using four parameters, air burst on time, off time, number of bursts, and time between burst patterns. FIG. 2 illustrates one exemplary cycle for the programmed air burst intervals.

Excess flow and controlled flow out of the priority flow control is joined together post filter and returned to the tank 12 to extend the life of the filter elements. The tank is vented to the atmosphere through a breather valve and any liquid is captured in a bottle 34 to prevent operators from breathing vapors. Fluid temperature, flow, pressure, tank level, and filter status are monitored by the sensors and displayed to the user.

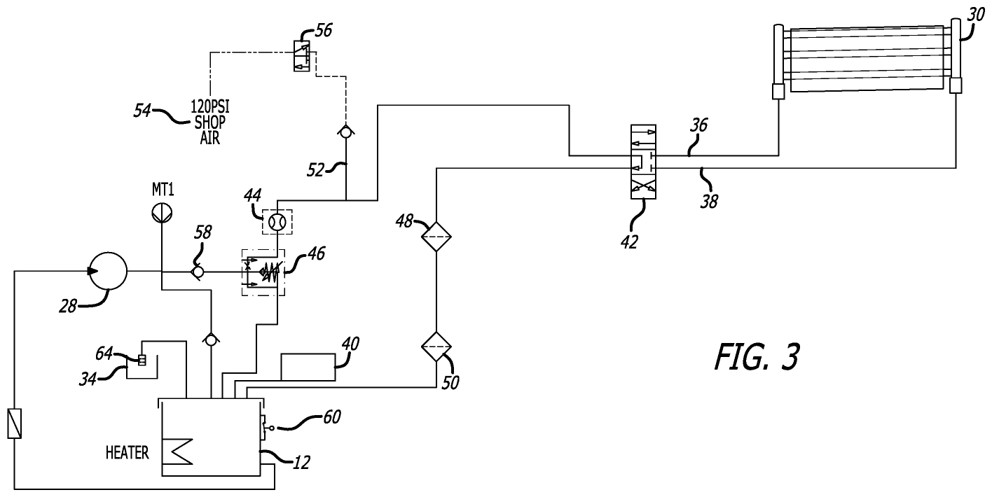

FIG. 3 illustrates a schematic of a first preferred embodiment of the present invention showing the major components of the fluid exchange machine. The vehicle's radiator 30 is shown connected by the two hoses 36, 38 to component and lines being flushed. The tank 12 is filled with fresh fluid and includes a pressure transducer MT1 to measure the back pressure and pressure in the hydraulic circuit during the fluid exchange operation. The tank 12 includes a heating element 90 that can be used to elevate the temperature of the fluid to be circulated. The pressure data is fed to a controller 40 that can be used to monitor and control the air delivery and fluid flow rates. The hoses 36, 38 are equipped with a flow reversing valve 42 to control the direction of the flow into and out of the transmission 30. Upstream of the reversing valve on the first hose is a flow meter 44 and check valve 58, and downstream of the reversing valve on the second hose is a sixty micron filter screen 48 and a ten to twenty micron absolute filter 50. The filter screen 48 is used to visually inspect the fluid exiting the transmission to determine the level of contaminants and fouling, and to determine when the fluid exchange is sufficiently complete. Between the flow meter 44 and the reversing valve 42 on the first hose 36 is an air line 52 that is connected to a pressurized source of air 54. A solenoid 56 may be located on the air line 52 to control the air injection either manually or automatically.

Each of the first and second hoses 36, 38 is connected at their opposite end to a manually operated reverser valve 46. The tank 12 includes a level switch 60 that can cease operation of the machine 10 if the fluid level drops below a predetermined level that makes it unsafe to continue. The tank 12 is connected to a motor 26 and pump 28 to feed the manually operated priority flow control valve 46. A pressure transducer MT1 is disposed between the motor/pump to monitor the pressure of the fluid leaving the pump. This information is also conveyed to the controller 40 for managing the system.

The fixed displacement gear pump 28 is preferably driven by a single phase AC motor 26. Fluid flows past the pressure sensor MT1 and into manual priority flow control valve 46 (pressure compensated with internal 120 psi relief valve). The flow passes through the check valve 58 and a 0-10 gallons per minute positive displacement flow meter 44. The air injection line 52 attaches just after flow meter 44. With or without air injection, the flow moves into the open center reversing valve 42 and then into component 30 being flushed, and then back to the reversing valve 42 and into the fine mesh screen filter 48. After exiting the filter, the flow moves into a dual paper based spin on filter or 10-20 micron absolute filter 50. Excess flow and controlled flow moves out of priority flow control tee together after cellulose filter and return to the tank 12. The tank 12 is vented to atmosphere through a diffuser 64 and bottle 34.

When the user begins the operation, a program automatically starts the motor/pump operation and runs for specified periods of times selectable by the user. Air injection may be programmatically controlled using the controller 40. Specifically the controller has the option of selecting an air injection pattern based on the measured flow rate if enabled. Temperature, flow, and pressure are monitored and reported to the user via the LED display. Air injection is not performed upon initial startup of flush cycle and at the end of flush cycle so that accurate reading of flow and pressure can be obtained.

While the foregoing describes one preferred embodiment, one skilled in the art will readily recognize that there are many different substitutions and rearrangements of the various components that would still function within the scope and spirit of the invention. Therefore, the invention should not be construed as limited to any single embodiment described or depicted, but rather the invention's scope is measured by a totality of the information provided.

I claim:

1. A fluid exchange machine, comprising:
a chassis having at least a pair of wheels mounted on an axle;
a fluid tank supported on the axle, the fluid tank having a heating element and a level switch;
an air vent diffuser in fluid communication with the fluid tank;
a controller;
a variable speed motor and pump combination for causing a fluid flow;
a pressure transducer in fluid communication with the fluid tank;
a flow meter;
a flow control valve;
first and second hoses connectable to a vehicle cooling lines and heat exchanger;
a dedicated air line configured to inject air into the fluid flow; and
a reversing valve for reversing a direction of the fluid flow.

2. The fluid exchange machine of claim 1, further comprising a filter screen for visually inspecting a purity of the fluid flow.

3. The fluid exchange machine of claim 1, further comprising a temperature sensor for determining a temperature of the fluid flow.

4. The fluid exchange machine of claim 1, further comprising a solenoid valve between the air line and a source of pressurized air.

5. The fluid exchange machine of claim 4, further comprising a check valve disposed between the variable speed motor and pump combination, and the flow control valve.
